(19) United States
(12) Patent Application Publication
(10) Pub. No.: US 2026/0148201 A1
(43) Pub. Date: May 28, 2026

(54) APPARATUS AND METHOD FOR PREDICTING A REMAINING USEFUL LIFE

(71) Applicants: HYUNDAI MOTOR COMPANY, Seoul (KR); KIA CORPORATION, Seoul (KR)

(72) Inventors: Hyun Woo Jung, Hwaseong-si (KR); Su Woong Eo, Hwaseong-si (KR); Dae Un Sung, Hwaseong-si (KR); Sang Hyun Moon, Hwaseong-si (KR)

(73) Assignees: HYUNDAI MOTOR COMPANY, Seoul (KR); KIA CORPORATION, Seoul (KR)

(21) Appl. No.: 19/389,930

(22) Filed: Nov. 14, 2025

(30) Foreign Application Priority Data
Nov. 14, 2024 (KR) 10-2024-0161922
Oct. 1, 2025 (KR) 10-2025-0143453

(51) Int. Cl. G06Q 10/20

(52) U.S. Cl. CPC G06Q 10/20

(57) ABSTRACT

An apparatus and method for predicting a remaining useful life of equipment using accumulated damage, calculated in consideration of a history of variable and uncertain loads, as an independent variable is provided. A processor receiving data on irregular loads applied to a device, equipment, an apparatus, or a system determines whether an anomaly has occurred by inputting the data on the loads to an anomaly detection model, and calculates a remaining useful life of the equipment through a failure prediction model by setting accumulated damage as an independent variable based on determining whether the anomaly is occurring. The prediction accuracy of the remaining useful life is improved using accumulated damage, calculated in consideration of a history of uncertain loads, as an independent variable.

This application claims priority to Korean Patent Application No. 10-2024-0161922, filed on Nov. 14, 2024, and Korean Patent Application No. 10-2025-0143453, filed on Oct. 1, 2025 which are hereby incorporated by reference as if fully set forth herein.

### BACKGROUND OF THE DISCLOSURE

### Field of the Disclosure

The present disclosure relates to an apparatus and method for predicting a remaining useful life, and more particularly, to an apparatus and method for predicting a remaining useful life of equipment using accumulated damage, calculated in consideration of a history of variable and uncertain loads, as an independent variable.

### Discussion of the Related Art

Because vehicle components are subjected to vibrations and loads transmitted from the road surface during driving, durability is an important factor.

In order to predict the lifespan of vehicle components, preset loads are applied to the vehicle components, the degree of shaking, the degree of impact, and strength variation are measured, and the measurement values are recorded. Thereafter, recorded data is input to a separate analysis apparatus, analog signals are converted into digital signals, and the strength and durability of the components are evaluated through a preset computation algorithm, thereby predicting the lifespans of the components.

In remaining useful life (RUL) prediction technology according to the related art, as shown in FIG. 1A, when time is used as an independent variable (x) and a constant load value is used as a dependent variable (y), or as shown in FIG. 1B, when a load value has a cycle, regression analysis is performed to predict the remaining useful life (RUL).

However, in vehicles, aircraft, ships, and the like, the types and magnitudes of loads vary depending on driving methods and environmental conditions. For example, in the case of a vehicle, there exists uncertainty resulting from variations in driving conditions, such as speeding, sudden braking, and the number of passengers, as well as environmental conditions, such as road conditions and ambient temperature. Therefore, a remaining useful life prediction method that uses time or cycles as an independent variable under constant or repetitive load conditions is not suitable for equipment operating under variable driving conditions. Accordingly, as shown in FIG. 1C, a remaining useful life prediction method capable of inherently considering variably changing and uncertain load conditions is required.

### SUMMARY OF THE DISCLOSURE

Accordingly, embodiments are directed to an apparatus and method for predicting a remaining useful life that substantially obviate one or more problems due to limitations and disadvantages of the related art.

An aspect of the present disclosure is to provide an apparatus and method for predicting a remaining useful life of equipment which loads having variable and uncertain magnitudes are applied.

Another aspect of the present disclosure is to provide an apparatus and method for predicting a remaining useful life of equipment by utilizing accumulated damage, calculated based on a history of loads applied to the equipment, as an independent variable.

However, the aspects to be accomplished by the embodiments are not limited to the above-mentioned aspects, and other aspects not mentioned herein should be clearly understood by those having ordinary skill in the art from the following description.

Additional advantages, aspects, and features of the disclosure are set forth in part in the description which follows and in part should become apparent to those having ordinary skill in the art upon examination of the following or may be learned from practice of the disclosure. The aspects and other advantages of the disclosure may be realized and attained by the structure particularly pointed out in the written description and claims hereof as well as the appended drawings.

An apparatus for predicting a remaining useful life according to the present disclosure for accomplishing the above aspects may include a plurality of sensors configured to detect loads applied to equipment of a vehicle, a memory configured to store a history of loads measured by the plurality of sensors, and a processor configured to determine whether an anomaly has occurred by inputting data on the loads to an anomaly detection model and to calculate a remaining useful life of the equipment through a failure prediction model by setting an accumulated damage as an independent variable.

In the apparatus for predicting a remaining useful life according to the present disclosure, the vehicle may include an internal combustion engine vehicle including an engine as a power source, a hybrid vehicle including an engine and an electric motor as power sources, or an electric vehicle including an electric motor as a power source.

In the apparatus for predicting a remaining useful life according to the present disclosure, the processor may be included in a vehicle electronic control system mounted in the vehicle.

In the apparatus for predicting a remaining useful life according to the present disclosure, the processor may be included in a server configured to perform wireless communication with a communication device of the vehicle.

In the apparatus for predicting a remaining useful life according to the present disclosure, the data on the loads applied to the vehicle may include at least one of a static load, a dynamic load, a road load, an environmental load, or a fatigue load.

In the apparatus for predicting a remaining useful life according to the present disclosure, the processor may be configured to receive the data on the loads from the plurality of sensors mounted in the equipment, calculate a health index indicating a degradation level of the equipment caused by the loads in a mathematical form, substitute the health index as a variable of the anomaly detection model, and compare a result obtained from the anomaly detection model with a threshold value to determine whether an anomaly has occurred.

In the apparatus for predicting a remaining useful life according to the present disclosure, the anomaly detection model may include a Mahalanobis distance.

In the apparatus for predicting a remaining useful life according to the present disclosure, in order to generate the accumulated damage, the processor may be configured to derive load variables for the data on the loads, calculate incremental damage according to the load variables based on damage mechanics, and update current accumulated damage incorporating the incremental damage.

In the apparatus for predicting a remaining useful life according to the present disclosure, the incremental damage may be calculated using Miner's rule.

In the apparatus for predicting a remaining useful life according to the present disclosure, the processor may be configured to set the accumulated damage containing information on a load history as an independent variable, set a health index resulting from changes in the accumulated damage as a dependent variable, substitute the health index into the failure prediction model, and divide a remaining damage value by an average damage rate to calculate the remaining useful life.

A method of predicting remaining useful life according to the present disclosure may include determining, by a processor receiving data on loads applied to equipment of a vehicle, whether an anomaly has occurred by inputting the data on the loads to an anomaly detection model, and calculating, by the processor, a remaining useful life of the equipment through a failure prediction model by setting accumulated damage as an independent variable based on determining that the anomaly is occurring.

It is to be understood that both the foregoing general description and the following detailed description of the present disclosure are explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIGS. 1A-1C are graphs showing load information when time is used as an independent variable.

FIG. 2 is a block diagram schematically showing the configuration of an apparatus for predicting a remaining useful life according to an embodiment of the present disclosure.

FIG. 3 is a flowchart showing a method of predicting a remaining useful life according to an embodiment of the present disclosure.

FIG. 4 is a flowchart showing a process of determining the possibility of an anomaly occurring in equipment based on load data in the method of predicting a remaining useful life according to an embodiment of the present disclosure.

FIG. 5 is a flowchart showing a process of calculating accumulated damage information in the apparatus and method for predicting a remaining useful life according to an embodiment of the present disclosure.

FIG. 6 is a flowchart showing a process of calculating a remaining useful life by inputting accumulated damage to a failure prediction model in the method of predicting a remaining useful life according to an embodiment of the present disclosure.

FIG. 7 is a graph showing a concept of calculating a remaining useful life using accumulated damage in the apparatus and method for predicting a remaining useful life according to an embodiment of the present disclosure.

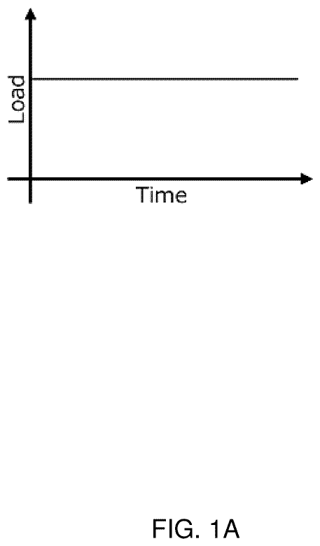

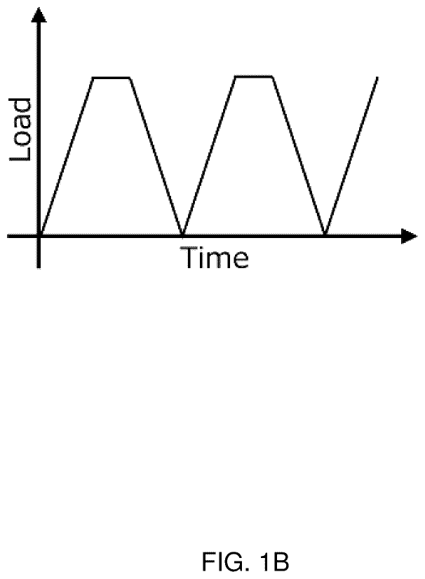

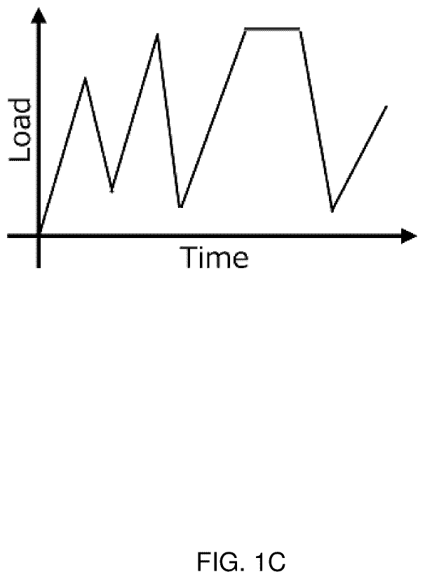

### DETAILED DESCRIPTION OF THE DISCLOSURE

Various embodiments are described more fully below with reference to the accompanying drawings, in which only some embodiments are shown. Specific structural and functional details disclosed herein are merely representative for the purpose of describing embodiments. The present disclosure, however, may be embodied in many alternative forms, and should not be construed as being limited to the embodiments set forth herein.

Accordingly, while embodiments of the disclosure are capable of being variously modified and taking alternative forms, embodiments thereof are shown by way of example in the drawings and are herein described in detail. It should be understood, however, that there is no intent to limit the present disclosure to the particular embodiments disclosed. On the contrary, embodiments are to cover all modifications, equivalents, and alternatives falling within the scope of the disclosure.

It should be understood that, although the terms “first,” “second,” and the like may be used herein to describe various elements, these elements should not be limited by these terms. These terms are only used to distinguish one element from another. For example, a first element could be termed a second element, and, similarly, a second element could be termed a first element, without departing from the scope of embodiments of the present disclosure.

It should be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between,” “adjacent” versus “directly adjacent,” and the like). Similarly, it should be understood that, when an element is referred to as being “disposed on” another element, it may be directly disposed on the surface of the other element or may be disposed above the surface of the other element with a spacing distance therefrom.

The terminology used herein is for the purpose of describing particular embodiments only and is not intended to be limiting of embodiments of the disclosure. As used herein, the singular forms are intended to include the plural forms as well, unless the context clearly indicates otherwise. It should be further understood that the terms “comprises,” “comprising,” “includes,” and/or “including,” when used herein, specify the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

When a certain embodiment is capable of being realized in a different manner, functions or operations specified in a specific block may be executed in an order different from that shown in a flowchart. For example, two consecutive blocks may be executed simultaneously, or may be executed in the reverse order, depending on the related function or operation.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Hereinafter, an apparatus and method for predicting a remaining useful life according to the present disclosure are described with reference to the accompanying drawings. The apparatus for predicting a remaining useful life according to the present disclosure may be applied to devices, apparatuses, equipment, or systems, the useful life of which is reduced due to loads applied thereto during operation. In the following description, equipment is illustrated for explanation. However, this is merely for illustrative purposes and does not mean that the present disclosure is limited to predicting the remaining useful life of equipment. In addition, the equipment may be, or be part of, a transportation means, such as a vehicle, a ship, or an aircraft, or production equipment used in manufacturing industrial products at an industrial site. In the following description, a vehicle is illustrated as the equipment or as including the equipment. For example, the vehicle may include an internal combustion engine vehicle including an engine as a power source, a hybrid vehicle including both an engine and an electric motor as power sources, or an electric vehicle including an electric motor as a power source.

The apparatus for predicting a remaining useful life of a vehicle, or equipment or components of a vehicle, may be included in a vehicle electronic control system mounted in the vehicle. In another embodiment, when the vehicle is a connected car capable of transmitting and receiving data to and from an external system via a wireless network (Internet, 5G, or satellite), the apparatus for predicting a remaining useful life may be included in a server capable of performing wireless data communication with the vehicle.

The following description is given based on a configuration in which the apparatus for predicting a remaining useful life is mounted in a vehicle electronic control system. However, the present disclosure is not limited thereto.

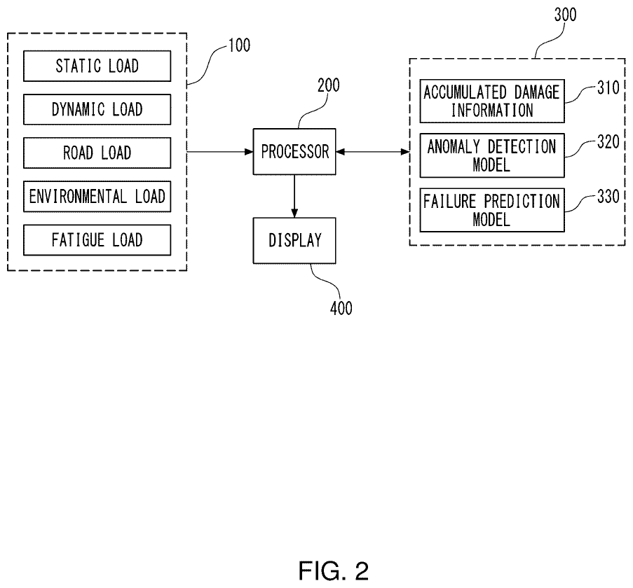

FIG. 2 is a block diagram schematically showing the configuration of the apparatus for predicting a remaining useful life according to an embodiment of the present disclosure. As shown, the apparatus for predicting a remaining useful life according to the present disclosure includes a sensor 100, a processor 200, a memory 300, and a display 400. When the apparatus for predicting a remaining useful life is mounted in a server that performs wireless communication with a vehicle, the apparatus may provide calculated remaining useful life information to the vehicle via a communicator.

The sensor 100 provides data on various loads acting on the vehicle (or on equipment of the vehicle). The load data provided by the sensor 100 may include a static load, a dynamic load, a road load, an environmental load, and a fatigue load.

The static load includes a load that acts constantly when the vehicle is in a stationary state. For example, the static load may include the weights of a vehicle body, an engine, and a battery as well as the weights of passengers or cargo. Such a static load may affect the vehicle body, chassis, suspension, and the like.

The dynamic load is a load that varies due to acceleration, deceleration, or cornering during vehicle driving. When the vehicle speed increases rapidly, the load on the rear wheels of the vehicle increases, and when the vehicle is rapidly braked, the load on the front wheels of the vehicle increases. In addition, when the vehicle turns a corner, the lateral load on the tires and the suspension increases due to centrifugal force. This may affect the lateral acceleration and the tire grip.

The road load may include a load that occurs instantaneously due to road irregularities or speed bumps, a load resulting from road friction, and a load caused by gravity when traveling uphill or downhill.

The environmental load may include loads resulting from thermal expansion and degradation due to changes in the temperature of components such as the engine, the battery, or the brakes as well as loads caused by humidity, corrosion, or wind.

The fatigue load refers to the possibility of cracking over time due to accumulation of fatigue resulting from various repeatedly applied loads.

The memory 300 stores a history of loads measured by the sensor 100. The memory 300 stores accumulated damage information 310, an anomaly detection model 320, and a failure prediction model 330.

The processor 200 inputs load data provided from the sensor 100 to the anomaly detection model 320 to determine whether an anomaly has occurred, and sets the accumulated damage as an independent variable to calculate the remaining useful life (RUL) of the equipment through the failure prediction model 330.

The processor 200 performs control such that the display 400 displays the calculated remaining useful life in a form perceivable by the driver.

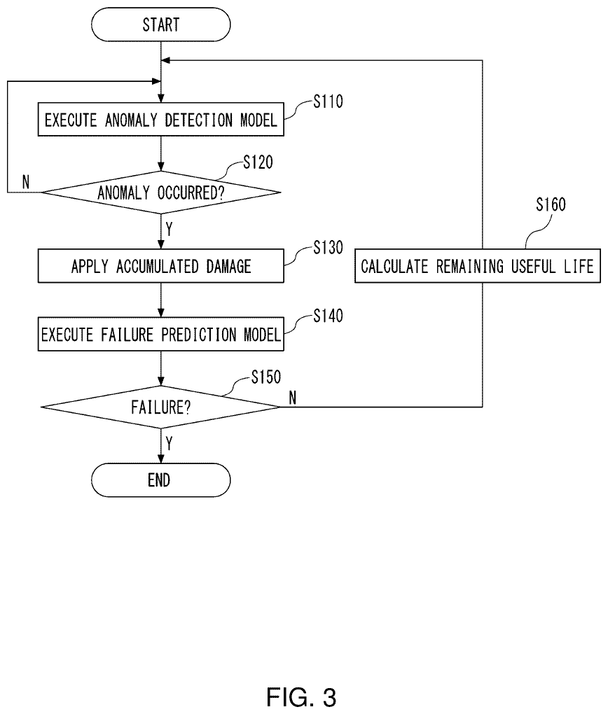

FIG. 3 is a flowchart showing a method of predicting a remaining useful life according to the present disclosure. The following description is given based on a configuration in which the processor is a main operating entity. The processor receives data on loads applied to the equipment, applies the load data to the anomaly detection model 320 (S110), and determines the possibility of anomaly occurrence (S120).

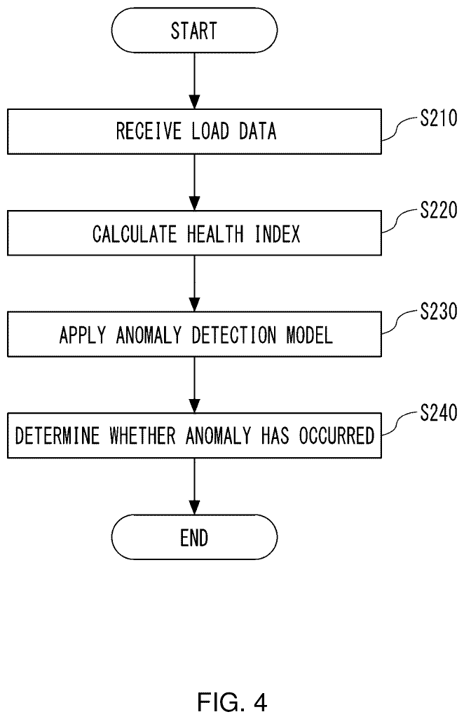

FIG. 4 is a flowchart showing a process of determining the possibility of anomaly occurring in the equipment based on the load data in the method of predicting a remaining useful life according to the present disclosure.

The processor 200 receives load data from a plurality of sensors mounted in the vehicle (S210).

The processor 200 calculates a health index that indicates the degradation level of the equipment caused by the above-described loads in a mathematical form (S220). The health index is an indicator that quantitatively represents the degradation level of a machine, a component, or a system. The health index is a numerical value that intuitively indicates how healthy the equipment is at the current time.

The processor 200 substitutes the calculated health index as a variable of the anomaly detection model 320 when applying the anomaly detection model (S230). For example, the Mahalanobis distance may be used as the anomaly detection model 320. Case values form a cluster around a centroid defined by mean values of multiple variables. The Mahalanobis distance is a distance value used to determine how far a value of a particular case deviates from the centroid.

The processor compares a result obtained from the anomaly detection model 320 with a threshold value. When the Mahalanobis distance is greater than the threshold value, the processor determines that there is a possibility of anomaly occurring in the equipment due to the loads (S240).

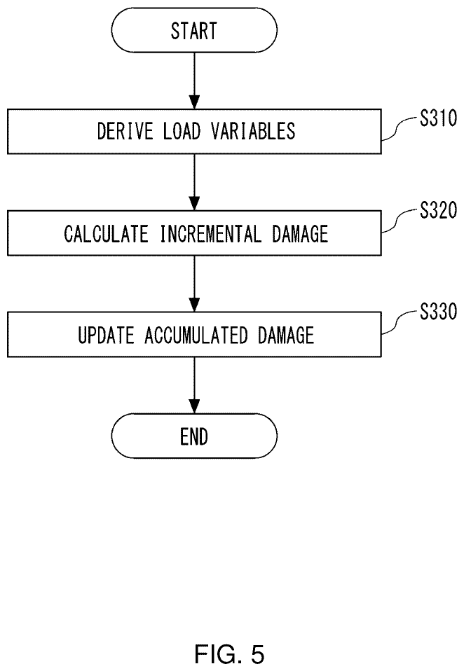

FIG. 5 is a flowchart showing a process of calculating accumulated damage information in the apparatus and method for predicting a remaining useful life according to the present disclosure.

The processor 200 derives load variables for the load data (S310). The processor derives load variables such as stress and temperature using relational expressions and analysis. Damage applied to the vehicle affects durability, safety, and reliability of the vehicle. In order to quantitatively identify the damage, various load variables applied to the vehicle need to be measured. The load variable refers to a physical quantity that repeatedly acts on structural components of the vehicle (such as the vehicle body, the chassis, or the tire) and causes fatigue damage, wear, or breakage.

The processor 200 calculates incremental damage according to the load variables based on damage mechanics (S320). The processor calculates incremental damage using Miner's rule. Miner's rule is the most widely used accumulated damage model, which assumes that fatigue damage accumulates linearly. Miner's rule may be expressed using the following equation.

$$D = Σ \frac{Δ {N}_{1}}{{N}_{f 1} ( {A}_{1} , {B}_{1} , … )} + \frac{Δ {N}_{2}}{{N}_{f 2} ( {A}_{2} , {B}_{2} , … )} + …$$

D represents damage, N_{f} represents fatigue life, ΔN represents elapsed cycle, and A and B represent load variables.

The processor 200 applies the incremental damage to a previously stored accumulated damage value. The processor updates the data stored in the memory with the current accumulated damage into which the incremental damage is incorporated (S330). The accumulated damage refers to a sum of damage values caused by various types of loads, such as temperature changes, load changes, and rapid speed changes.

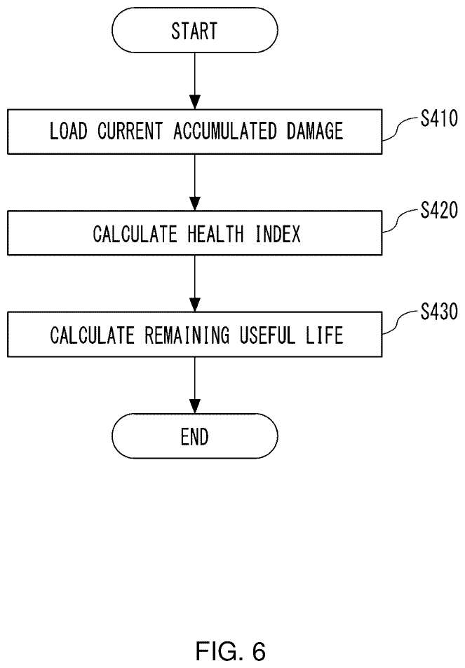

FIG. 6 is a flowchart showing a process of calculating a remaining useful life by inputting accumulated damage to the failure prediction model in the method of predicting a remaining useful life according to the present disclosure.

The processor 200 loads accumulated damage containing information on a load history, and sets the same as an independent variable (S410). Subsequently, the processor 200 sets a health index resulting from changes in the accumulated damage as a dependent variable, and inputs the same to the failure prediction model 330 (S420). In addition to the health index, a degradation level or a precursor may be set as the dependent variable.

The failure prediction model may employ a curve-fitting method, a physics-based method, or an artificial intelligence (AI)-driven method.

The curve-fitting method is a technique of predicting a failure time and a remaining useful life by regressing degradation data with a linear function, a polynomial function, or the like.

The physics-based method is a technique of predicting a failure time and a remaining useful life by regressing degradation data using a known degradation model.

The AI-driven method is a technique that utilizes an AI model when the degradation mechanism is not sufficiently understood.

The processor 200 calculates a remaining useful life by dividing a remaining damage value by an average damage rate (S430).

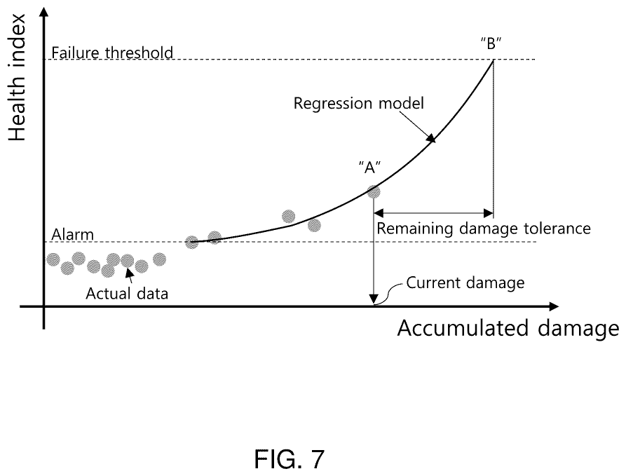

FIG. 7 is a graph showing a concept of calculating a remaining useful life using accumulated damage in the apparatus and method for predicting a remaining useful life according to the present disclosure. The processor 200 may optimize an average damage rate calculation section in order to improve the prediction accuracy of the remaining useful life (RUL). In the regression model, “A” represents the accumulated damage value applied to the vehicle up to the present, and “B” represents a failure threshold at which the vehicle fails. The interval from “A” to “B” represents remaining damage resistance. When the accumulated damage value exceeds an “Alarm” value, a warning may be displayed to the driver.

As described above, the apparatus and method for predicting a remaining useful life according to the present disclosure may improve the prediction accuracy of the remaining useful life using accumulated damage, calculated in consideration of a history of uncertain loads, as an independent variable.

As is apparent from the above description, according to the apparatus and method for predicting a remaining useful life according to the present disclosure, accumulated damage calculated based on a history of uncertain loads may be used as an independent variable, thereby increasing the prediction accuracy of a remaining useful life.

Although the embodiments of the present disclosure have been disclosed for illustrative purposes, those having ordinary skill in the art will appreciate that various modifications, additions and substitutions are possible, without departing from the scope and spirit of the disclosure as disclosed in the accompanying claims.

What is claimed is:

1. An apparatus for predicting a remaining useful life of equipment of a vehicle, the apparatus comprising:
a plurality of sensors configured to detect loads applied to the vehicle;
a memory configured to store a history of the loads measured by the plurality of sensors; and
a processor configured to determine whether an anomaly has occurred by inputting data on the loads to an anomaly detection model and to determine the remaining useful life of the equipment through a failure prediction model by setting an accumulated damage as an independent variable.

2. The apparatus according to claim 1, wherein the vehicle comprises an internal combustion engine vehicle including an engine as a power source, a hybrid vehicle including an engine and an electric motor as power sources, or an electric vehicle including an electric motor as a power source.

3. The apparatus according to claim 1, wherein the processor is included in a vehicle electronic control system mounted in the vehicle.

4. The apparatus according to claim 1, wherein the processor is included in a server configured to perform wireless communication with a communication device of the vehicle.

5. The apparatus according to claim 1, wherein the data on the loads applied to the vehicle comprises at least one of a static load, a dynamic load, a road load, an environmental load, or a fatigue load.

6. The apparatus according to claim 1, wherein the processor is configured to:
receive the data on the loads from the plurality of sensors mounted in the equipment;
determine a health index indicating a degradation level of the equipment caused by the loads in a mathematical form;
substitute the health index as a variable of the anomaly detection model; and
compare a result obtained from the anomaly detection model with a threshold value to determine whether the anomaly has occurred.

7. The apparatus according to claim 6, wherein the anomaly detection model comprises a Mahalanobis distance.

8. The apparatus according to claim 1, wherein the processor is further configured to generate the accumulated damage by:
deriving load variables for the data on the loads;
calculating incremental damage according to the load variables based on damage mechanics; and
updating current accumulated damage incorporating the incremental damage.

9. The apparatus according to claim 8, wherein the incremental damage is determined using Miner's rule.

10. The apparatus according to claim 1, wherein the processor is further configured to:
set the accumulated damage containing information on a load history as an independent variable;
set a health index resulting from changes in the accumulated damage as a dependent variable and substitute the health index into the failure prediction model; and
divide a remaining damage value by an average damage rate to determine the remaining useful life.

11. A method of predicting a remaining useful life of equipment of a vehicle, the method comprising:
determining, by a processor receiving data on loads applied to the equipment, whether an anomaly has occurred by inputting the data on the loads to an anomaly detection model; and
determining, by the processor, the remaining useful life of the equipment through a failure prediction model by setting an accumulated damage as an independent variable based on determining whether the anomaly is occurring.

12. The method according to claim 11, wherein the vehicle comprises an internal combustion engine vehicle comprising an engine as a power source, a hybrid vehicle comprising an engine and an electric motor as power sources, or an electric vehicle comprising an electric motor as a power source.

13. The method according to claim 11, wherein the processor is included in a vehicle electronic control system mounted in the vehicle.

14. The method according to claim 11, wherein the processor is included in a server configured to perform wireless communication with a communication device of the vehicle.

15. The method according to claim 11, wherein the data on the loads applied to the equipment comprises at least one of a static load, a dynamic load, a road load, an environmental load, or a fatigue load.

16. The method according to claim 11, wherein determining whether the anomaly has occurred comprises:
receiving, by the processor, the data on the loads from a plurality of sensors mounted in the equipment;
determining, by the processor, a health index indicating a degradation level of the equipment caused by the loads in a mathematical form;
substituting, by the processor, the health index as a variable of the anomaly detection model; and
comparing, by the processor, a result obtained from the anomaly detection model with a threshold value to determine whether the anomaly has occurred.

17. The method according to claim 16, wherein the anomaly detection model comprises a Mahalanobis distance.

18. The method according to claim 11, wherein the processor is further configured to generate the accumulated damage by:
deriving load variables for the data on the loads;
determining incremental damage according to the load variables based on damage mechanics; and
updating current accumulated damage incorporating the incremental damage.

19. The method according to claim 18, wherein the incremental damage is determined using Miner's rule.

20. The method according to claim 11, wherein determining the remaining useful life of the equipment comprises:
setting, by the processor, accumulated damage containing information on a load history as an independent variable;
setting, by the processor, a health index resulting from changes in the accumulated damage as a dependent variable and substituting the health index into the failure prediction model;
dividing, by the processor, a remaining damage value by an average damage rate to determine the remaining useful life; and
displaying information on the determined remaining useful life in a form perceivable by a user.
